(19) United States
(12) Patent Application Publication
(10) Pub. No.: US 2009/0136205 A1
(43) Pub. Date: May 28, 2009

(54) VIDEO RECORDING APPARATUS AND VIDEO RECORDING SYSTEM

(76) Inventors: Naofumi Tomita, Kokubunji (JP); Takahiro Iwata, Kokubunji (JP); Keita Asakura, Yokohama (JP); Shigeki Higashijima, Beijing (CN)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/259,320

(22) Filed: Oct. 28, 2008

(30) Foreign Application Priority Data
Oct. 29, 2007 (JP) 2007-279779

(51) Int. Cl. H04N 5/91

(52) U.S. Cl. 386/83; 386/E09.001; 725/58

(57) ABSTRACT

A video recording apparatus wherein in the case where video recording programming information generated by an automatic video recording programming control unit is already present in a video recording programming information table, the video recording programming information is recorded in duplicated video recording information table. In the case where other video recording apparatuses connected via network cancelled the video recording programming information, which had been registered in the duplicated video recording information table, a video recording programming control unit stores the video recording programming information in a video recording programming table, and a video recording control unit executes video recording, based on the video recording programming information table. In the case where video recording programming information, which had been registered in the duplicated video recording information table, was executed by a video recording apparatus connected via network, the video recording programming information is controlled by own directory of a contents information table.

### INCORPORATION BY REFERENCE

The present application claims priority from Japanese application JP2007-279779 filed on Oct. 29, 2007, the content of which is hereby incorporated by reference into this application.

### BACKGROUND OF THE INVENTION

The present invention relates to a video recording system where a plurality of video recording apparatuses are connected by network, particularly, the present invention relates to a control method for recording programming executed by a plurality of video recording apparatuses.

In recent years, there has been commercialized a system, where a plurality of imaging apparatuses such as a TV and recorder are connected via network and a picture image recorded on a recorder can be viewed on TV via network. In such a system, there may also be the case where a plurality of recorders are connected to network, and video recording programming of the same broadcast picture image is executed by different users by each recorder independently. As a result, there is a problem that a memory apparatus of a recorder cannot be utilized effectively, due to recording of the same broadcast picture image in a recorder.

In order to solve the above problem, there is described, in JP-A-2004-222014, a technology relating to a system for enhancing utilization efficiency of a recording medium, by preventing video recording of the same program by a plurality of video recording apparatuses, in a system configured by a plurality of video recording apparatuses connected via network.

For details, JP-A-2004-222014 has disclosed a system where in the case where a plurality of video recording apparatuses are connected via network, and video recording of the same program is programmed by a plurality of video recording apparatuses, inquiry is made to other recorders by a daisy chain mode, from a recorder which has programmed to record the program, whether video recording of the same program has been programmed already or not, and when the program has been programmed already by other recorders, link information of a recorder already programmed for video recording is recorded to the relevant recorder.

### SUMMARY OF THE INVENTION

However, in technology described in JP-A-2004-222014, because a plurality of video recording equipments connected via network forms a daisy chain for video recording programming in video recording of one program, each own video recording programming table or mechanism equivalent thereto is required, for example, in configuration of a system, which may raise a difficulty in programming video recording in cooperation with products of other company.

In addition, because the above technology has not given consideration to the case where video recording programming was changed by video recording equipment executing video recording of a program, it may occur that video recording of the program by video recording programming executed by other users cannot be executed.

The present invention has been proposed in view of the above problems, and it is an object of the present invention to provide a video recording system or a video recording apparatus with good operability, as well as attaining effective utilization of a memory apparatus of a video recording apparatus, by integrated control of video recording programming information, using a common protocol, for example, a protocol specified by a DLNA guideline, among a plurality of video recording apparatuses connecting via network.

A video recording apparatus of the present invention is configured so as to have a network sending and receiving unit for communicating with other video recording apparatuses via network; a contents data storage unit for recording broadcast program; a memory unit for recording a video recording programmed information table including broadcast program names, broadcast channels, recording date and time, and names of video recording apparatuses to be recorded in the contents data storage unit; a video recording control unit for recording broadcast program in the contents data storage unit, based on video recording programming information showing the relevant video recording apparatus by a video recording apparatus name of the video recording programming information table, with reference to the video recording programming information table; and a video recording programming control unit for setting the video recording programming information table, from video recording programming information specified by a user, and video recording programming information of other video recording apparatuses acquired via the network sending and receiving unit.

And, it is designed so that, the video recording programming control unit, in the case where the video recording programming information specified by the user has not been set to the video recording programming information table, registers the video recording programming information specified by the user in the video recording programming information table, and checks video recording programming information of other video recording apparatuses acquired via the network sending and receiving unit, and the video recording programming information table, and in the case where the video recording programming information is duplicated, updates the video recording programming information table, so that the video recording programming information is recorded by other video recording apparatuses, connecting to the network.

In addition, in a video recording system of the present invention, it is so that, when video recording is programmed in the first video recording apparatus by a user, a first video recording apparatus executes acquisition request of video recording programming information to a second video recording apparatus; the second video recording apparatus responds video recording programming information of the relevant apparatus to the first video recording apparatus; the first video recording apparatus checks video recording programming information of the relevant apparatus, and acquired video recording programming information of the second video recording apparatus; and as for duplicated video recording programs, a video recording programming information table of the apparatus is updated so as to show that video recording is executed by the second video recording apparatus.

According to the present invention, by executing video recording of a program by any one of a plurality of video recording apparatuses connected to network, and by executing reproduction request of a program, whose video recording was programmed, by a video recording apparatus or a reproducing apparatus which executed video recording programming, automatic transfer and reproduction of program picture image become possible from a video recording apparatus practically executed video recording of the program, therefore effective utilization of recording apparatuses of a plurality of video recording apparatuses can be attained.

In addition, even in the case where video recording programming is changed, video recording of a program can be surely executed, because a video recording apparatus for executing video recording of a program is automatically changed, as well as similar operation feeling can be provided as in reproduction viewing of the program, whose video recording is programmed.

Other objects, features and advantages of the invention will become apparent from the following description of the embodiments of the invention taken into conjunction with the accompanying drawings.

### BRIEF DESCRIPTION OF THE DRAWINGS

FIG. 1 is a drawing showing a video recording apparatus of the first embodiment of the present invention.

FIG. 2 is a drawing showing a video recording apparatus of the second or the third embodiment of the present invention.

FIG. 3 is a configuration diagram of a video recording system of the present invention.

FIG. 4 is a processing flow diagram of a video recording programming control unit of the first embodiment of the present invention.

FIG. 5 is a processing flow diagram of a video recording programming control unit of the second embodiment of the present invention.

FIG. 6 is other processing flow diagram of a video recording programming control unit of the second embodiment of the present invention.

FIG. 7 is a processing flow diagram of a contents information control unit of the third embodiment of the present invention.

FIG. 8 is an example of a video recording programming information table of a video recording apparatus of the present invention.

FIG. 9 is an example of a duplicated video recording information table of a video recording apparatus of the present invention.

FIG. 10 is an example of a contents information table of a video recording apparatus of the present invention.

FIG. 11 is an action sequence chart among video recording apparatuses of a video recording system of an embodiment of the present invention.

### DESCRIPTION OF THE EMBODIMENTS

Explanation will be given below in detail on embodiments of the present invention.

### Example 1

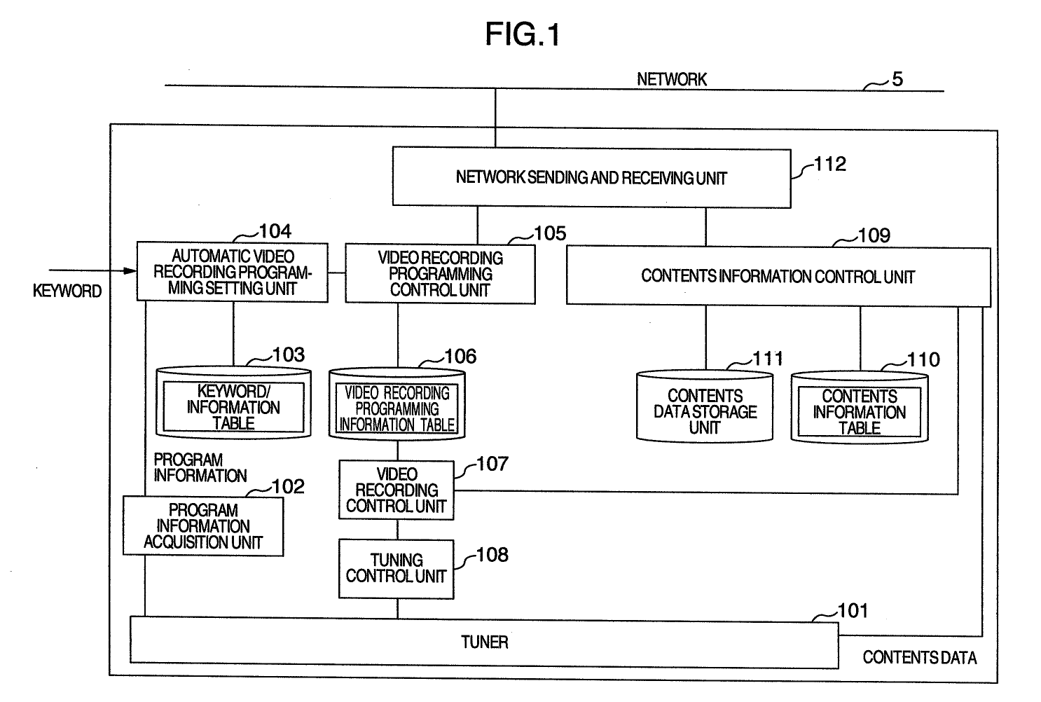

FIG. 1 is a configuration diagram of a video recording apparatus of the first embodiment of the present invention. Although detailed description will be given later, the video recording apparatus 1 is configured by a tuner 101, a program information acquisition unit 102, a keyword information table 103, an automatic video recording programming setting unit 104, a video recording programming control unit 105, a video recording programming information table 106, a video recording control unit 107, a tuning control unit 108, a contents information control unit 109, a contents information table 110, a contents data storage unit 111, and a network sending and receiving unit 112.

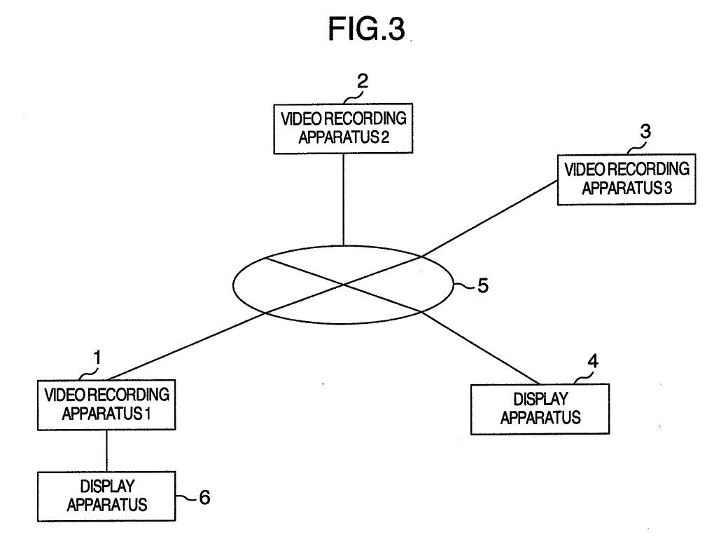

FIG. 3 is a system configuration diagram of a video recording system of the present invention. It is designed so that the video recording apparatus 1, a video recording apparatus 2, a video recording apparatus 3, and a display apparatus 4 are connected via network 5, and they are used in common in a program picture image system. The video recording apparatus 1 is connected with a display apparatus 6, so as to be capable of executing reproduction display of program picture image memorized in the video recording apparatus 1, by the display apparatus 6, as well as reproducing display of program picture image stored in the video recording apparatus 2 or the video recording apparatus 3 via network, by the display apparatus 6.

In addition, the display apparatus 4 is connected directly to network 5, and program picture image recorded in the video recording apparatus 1 or the video recording apparatus 2 or the video recording apparatus 3 is reproduced and displayed by the display apparatus 4. Sending and receiving of video recording programming information and contents information of the video recording apparatus and the display apparatus is executed, for example, by UPnP service etc., specified by UPnP Device Architecture, which is one of the configuration elements of a DLNA guideline.

Explanation will be given below in detail on configuration of the video recording apparatus 1.

The tuner 101 sets broadcast channel, based on direction of the tuning control unit 108, and receives broadcast information. This broadcast information includes a contents data, which is a broadcast program, or program information of a broadcast program, and the contents data received is recorded in the contents data storage unit 111, by video recording programming function to be described later, based on the program information.

Next, explanation will be given on outline of video recording programming and video recording of a program.

Explanation will be given in detail on the automatic video recording programming setting unit 104, with reference to FIG. 1. The automatic video recording programming setting unit 104 forms video recording programming information by making a program containing keywords in program information as a video recording subject, with reference to program information, which was acquired by a program information acquiring unit 102 by controlling the tuner 101, and a keyword information table 103, where a user set, in advance, keywords of a program of a video recording programming subject. This video recording programming information is registered in the video recording programming information table 106 by the video recording programming control unit 105.

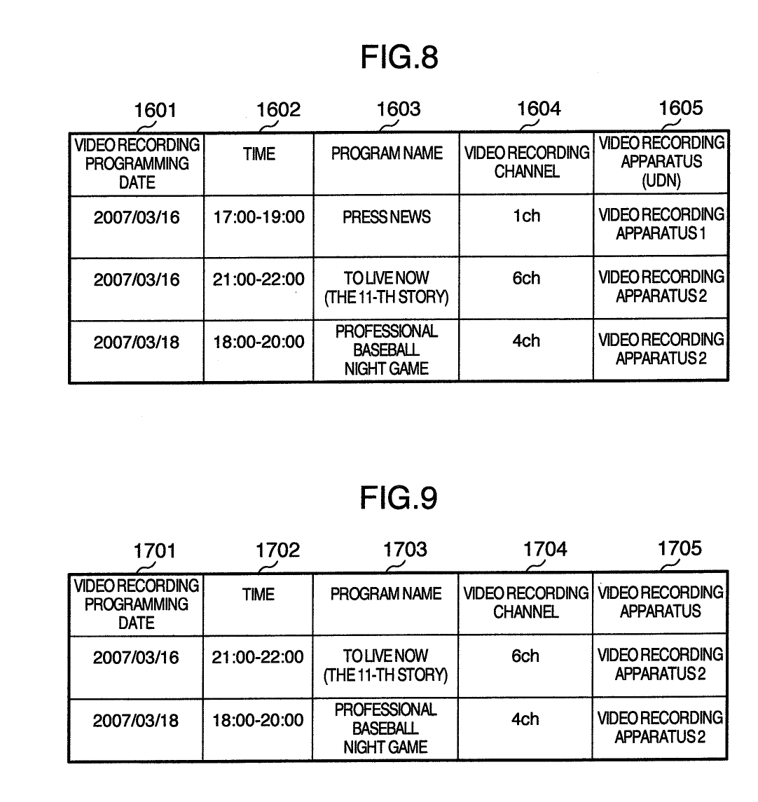

FIG. 8 is an example of the video recording programming information table 106. The video recording programming information table 106 is configured by items of a video recording programming date 1601, a video recording start and stop time 1602, a program name 1603, a video recording channel 1604, and a video recording apparatus 1605, and is referred by the video recording control unit 107. Here, the item of the video recording apparatus 1605 may be any one as long as it is information by which an apparatus can be specified on network, for example, UDN (Universal Device Name) is recorded.

The video recording control unit 107 notices a channel number, which has been set to the video recording channel 1604 of the video recording programming information table 106, to the tuning control unit 108, when date and time set in the video recording programming date 1601 and the video recording start and stop time 1602 come, about video recording programming information, where the video recording apparatus 1605 of the video recording programming information table 106 shows the relevant video recording apparatus, and starts receiving of a program whose video recording has been programmed. The contents data of received program is recorded on the contents data storage unit 111, as described above.

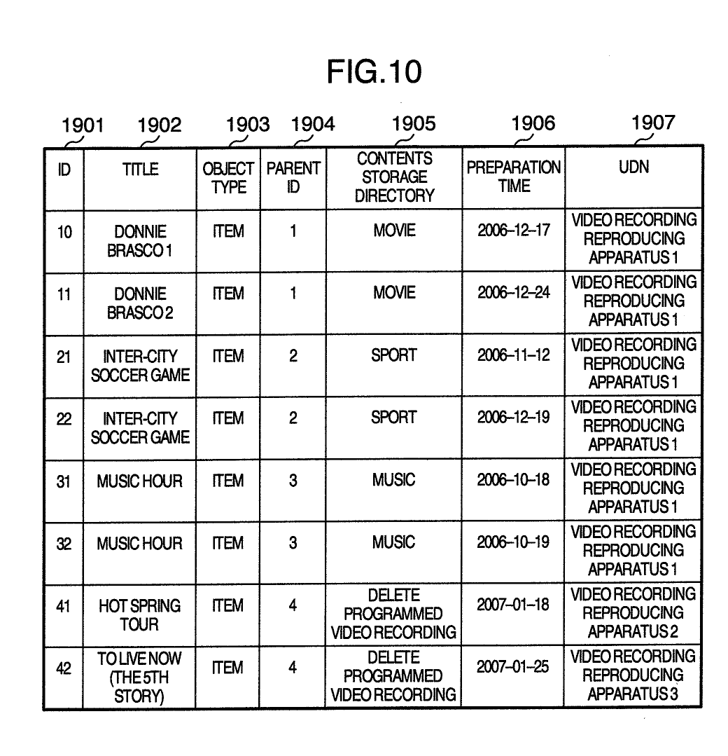

In this case, the contents information table 110 is also set. FIG. 10 shows an example of a contents data information table 110. The contents data information table 110 is configured by items of an object ID 1901, a title 1902, an object type 1903, a parent object ID 1904, a contents storage directory 1905, an object preparation time 1906, and a UDN 1907, so as to enable control of contents data recorded in the contents data storage unit 111.

For details, the object ID 1901, the title 1902, the object type 1903, and the parent object ID 1904 are type information of the contents, and the object preparation time 1906 shows time information of the contents, and the contents storage directory 1905 and the UDN 1907 show recording places of the contents.

Here, the UDN 1907 should not be limited to UDN (Universal Device Name), which is a unique device identifier to be furnished to a UPnP device, but any information, which is capable of specifying a video recording apparatus connected to network, may be accepted.

In addition, explanation was given on an example of the automatic video recording programming setting unit 104 by keywords, however, by user specification of program information acquired by the program information acquisition unit 102, similar programmed video recording can be executed, also in the case of setting to the video recording information table 106 by specifying a program for video recording.

Next, explanation will be given in detail about the video recording programming control unit 105 of the first embodiment of the present invention. As described above, programmed video recording of a broadcast program is executed by setting of a video recording programming information table 106, and in the case where new video recording programming information is generated and the same information as the video recording programming information is already present at the video recording programming information table 106, the video recording programming information is not registered in the video recording programming information table 106, and in the case where it is not present, it is registered in the video recording programming information table 106.

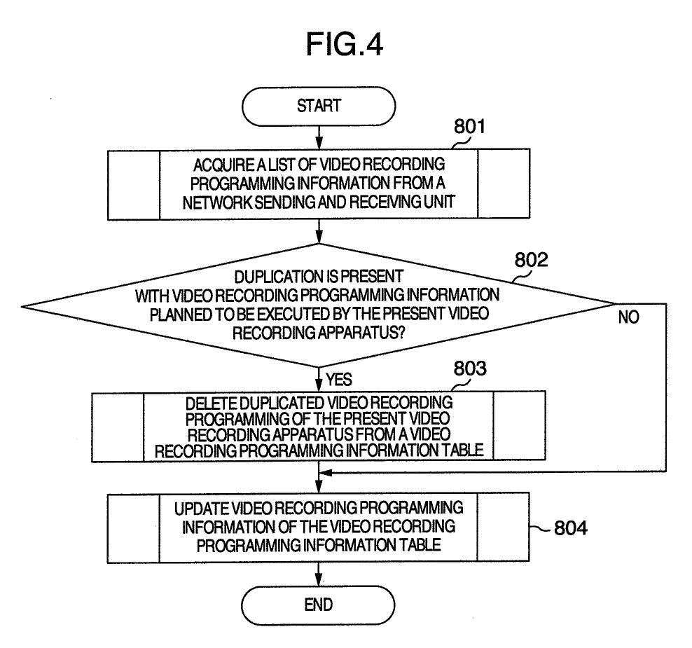

Further, the video recording apparatus 1 of the first embodiment of the present invention programms video recording in cooperation with the video recording apparatus 2 or video recording apparatus 3 connected to network, in accordance with a flow chart shown in FIG. 4. FIG. 4 is a drawing showing a processing flow chart of the video recording programming control unit 105.

When video recording programming information is set by the video recording apparatus 1, a list of video recording programming information of the video recording apparatus 2 and the video recording apparatus 3 connected via network is acquired via the network sending and receiving unit 112 of the video recording apparatus 1 (801). Whether duplication is present or not between video recording programming information planned to be set by the video recording apparatus 1, and video recording programming information of the video recording apparatus 2 and the video recording apparatus 3 is checked (802), and in the case where duplication is present, the duplicated video recording programming information of the present video recording apparatus is deleted from the video recording programming information table 106 of the video recording apparatus 1 (803). And, the list of the video recording programming information acquired from the video recording apparatus 2 and the video recording apparatus 3 is reflected in the video recording programming information table 106 (804). In the case where the duplication is not present, the list of the video recording programming information acquired is reflected in the video recording programming information table 106 (804).

In this way, in the video recording programming information table 106, the video recording programming information of the video recording apparatus 1, the video recording apparatus 2 and the video recording apparatus 3 connected to network, is recorded, and there is no duplicated programming of video recording. The video recording apparatus executing practically programmed video recording is distinguished by items of the video recording apparatus 1605 of the video recording programming information table 106.

Explanation was given above on the case where video recording programming information is set by the video recording apparatus 1, however, in the case where video recording programming information is set by the video recording apparatus 2 or the video recording apparatus 3, the video recording apparatus 1 sends contents of the video recording programming information table 106 to the video recording apparatus 2 or the video recording apparatus 3, which requested acquisition, to acquisition request of video recording programming information from the video recording apparatus 2 or the video recording apparatus 3.

In order to send and receive the contents of the video recording programming information table 106 among the video recording apparatuses connected to network as described above, contents list function of Content Directory Service of an UPnP device may be used.

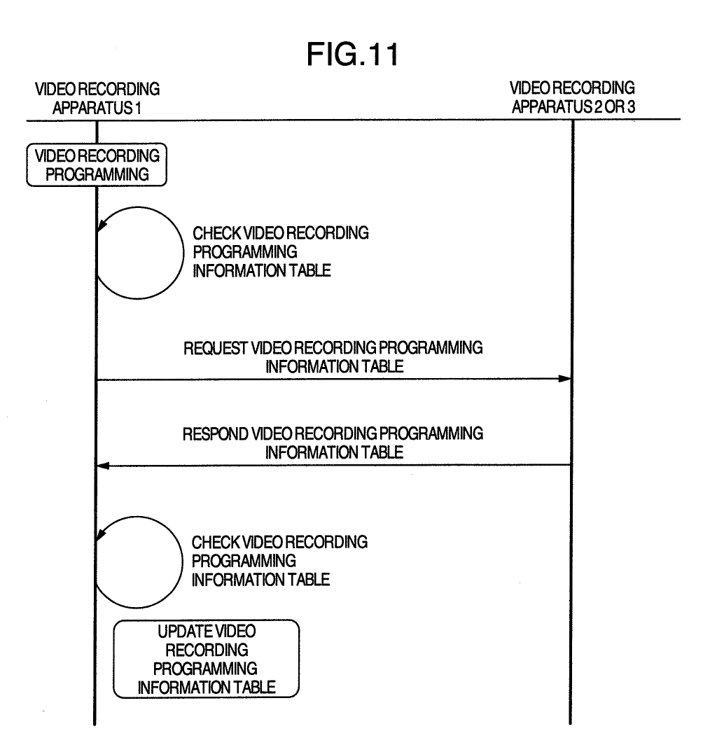

FIG. 11 shows a sequence among video recording apparatuses in a video recording system of an embodiment of the present invention. As described above, it shows an example of the case where video recording is programmed by the video recording apparatus 1. When the video recording programming information is set by the video recording apparatus 1, duplication check is executed whether it is already set at the video recording programming information table 106 of the video recording apparatus 1 or not. Subsequently, by acquiring the video recording programming information table from the video recording apparatus 2 and the video recording apparatus 3, duplication check is executed whether it is already set or not, and the video recording programming information table 106 is updated by the video recording programming information acquired.

In this way, by updating the video recording programming information table 106, based on the video recording programming information acquired from the video recording apparatus 2 and the video recording apparatus 3, the latest video recording programming information can be known, even when connection was impossible to the video recording apparatus 2 or the video recording apparatus 3, which provides duplication prevention effect of video recording programming.

### Example 2

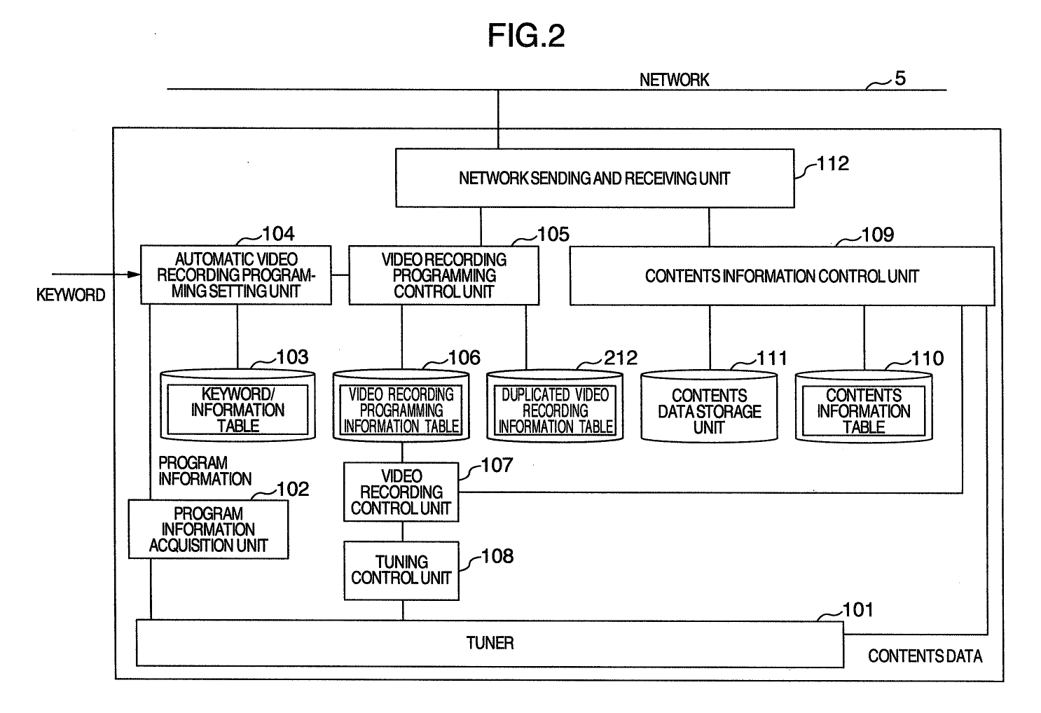

Next, explanation will be given on the second embodiment of the present invention. In this second embodiment of the present invention, explanation will be given on a response example in the case where a video recording programming state executed by other video recording apparatuses connected by network was changed. FIG. 2 is a configuration diagram of a video recording apparatus of this second embodiment.

The second embodiment has different configuration from that of the video recording apparatus of the first embodiment, in the point that the video recording apparatus of the second embodiment has a duplicated video recording information table 212, and explanation is omitted, because other configurations are the same as those in the video recording apparatus of the first embodiment of FIG. 1. Description will be given below only on contents relating to the duplicated video recording information table 212.

In the duplicated video recording information table 212, it is designed so that video recording programming information of the video recording apparatus of the present embodiment is recorded, when programming of video recording is executed by the video recording apparatus of the embodiment and in the case where duplication is present in video recording programming information of other video recording apparatuses connected to network. FIG. 9 shows an example of the duplicated video recording information table 212.

The duplicated video recording information table 212 is configured by items of a video recording programming date 1701, a video recording start and stop time 1702, a program name 1703, a video recording channel 1704, and a video recording apparatus 1705. These configurations are the same configuration as in the video recording programming table 106 explained in FIG. 8. Accordingly, it may be adopted a method not only for controlling the video recording programming table 106 and the duplicated video recording information table 212 as separate tables, as in the present embodiment, but also controlling by setting distinguishing items to the tables.

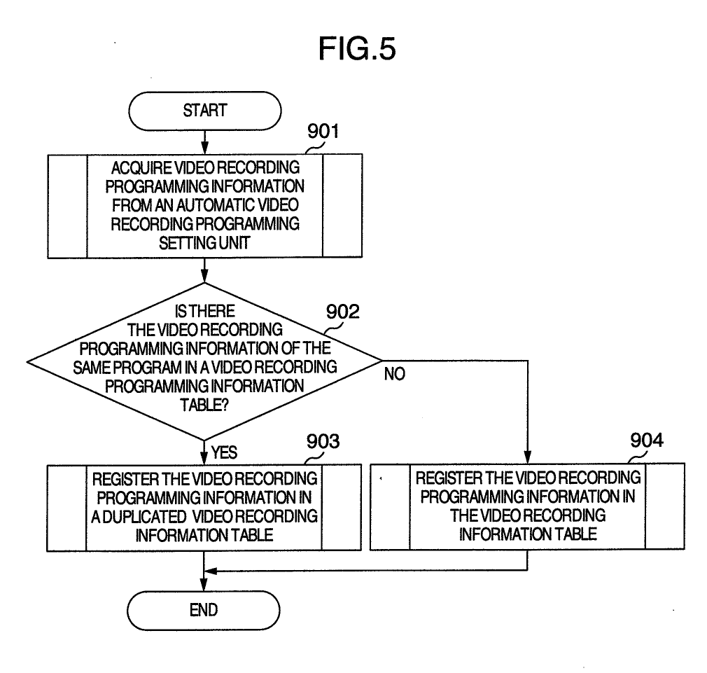

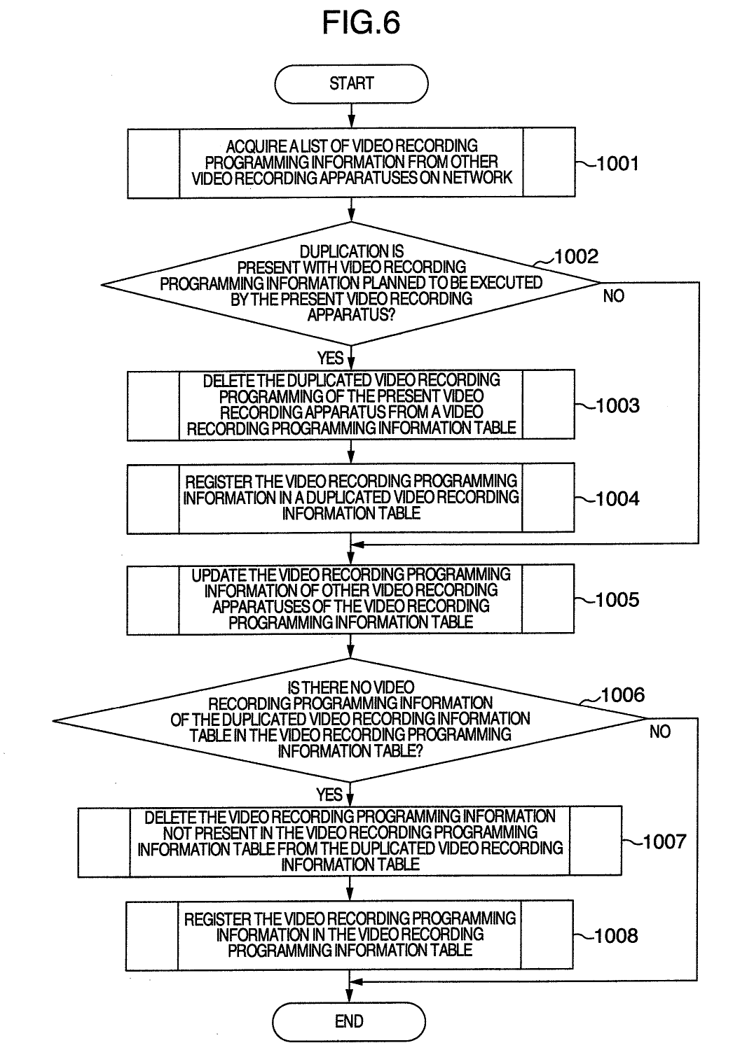

Explanation will be given in detail on a method for using the duplicated video recording information table 212 which is processed by the video recording programming control unit 205, with reference to the flow charts of FIG. 5 and FIG. 6. In the case where video recording programming information was acquired from the automatic video recording programming setting unit 204 (901), presence or absence of video recording programming information of the same program is checked (902), with reference to the video recording programming information table 206. As a result, in the case where the relevant video recording programming information is already present, the relevant video recording programming information is registered in the duplicated video recording information table 212 (903), whereas in the case of absence, the relevant video recording programming information is registered in the video recording programming information table 206 (904).

Next, in the case where a list of video recording programming information is acquired from the other video recording apparatuses connected via network (1001), duplication with video recording programming information planned to be executed by the present video recording apparatus, is checked (1002). In the case where duplication is present, the relevant duplicated video recording programming information of the present video recording apparatus is deleted from the video recording programming information table 206 (1003), and the relevant video recording programming information is registered in the duplicated video recording information table 212 (1004), and the list of video recording programming information acquired is reflected in the video recording programming information table 206 (1005). In the case of absence, the list of the video recording programming information acquired is reflected in the video recording programming information table 206 (1005).

Subsequently, whether video recording programming information of the duplicated video recording information table 212 is present in the video recording programming information table 206 or not is checked (1006). In the case where duplication is absent, video recording programming information, which is not present in the video recording programming information table 206, is deleted from the duplicated video recording information table 212 (1007), and the relevant deleted video recording programming information is registered in the video recording programming information table 206 (1008). In the case where duplication is present, processing is terminated.

According to the embodiment explained above, in the case where the relevant video recording programming information of other video recording apparatuses, which is duplicated with the video recording programming information of the present video recording apparatus, is cancelled, it is possible to execute video recording programming by the present video recording apparatus instead.

### Example 3

Next, explanation will be given on the third embodiment of the present invention. In this third embodiment, explanation will be given on a response example in the case where contents information of other video recording apparatuses connected to network, was changed. Configuration of the video recording apparatus of this third embodiment is the same as configuration of the video recording apparatus of FIG. 2, however, the contents information table 110 is configured as shown in FIG. 10.

For details, a contents information table 310 of FIG. 10 is configured by the object ID 1901, the title 1902, the object type 1903, the parent object ID 1904, the contents storage directory 1905, the object preparation time 1906, and the UDN 1907.

And, the contents information control unit 109, when contents information of other video recording apparatuses connected via network is changed, receives a contents information list via a network sending and receiving unit 113, and in the case where the relevant contents information list contains contents information coincident with the video recording programming information registered in the duplicated video recording information table 212, stores the relevant contents information in own directory of the contents information table 110, while in the case where it is absent, terminates processing.

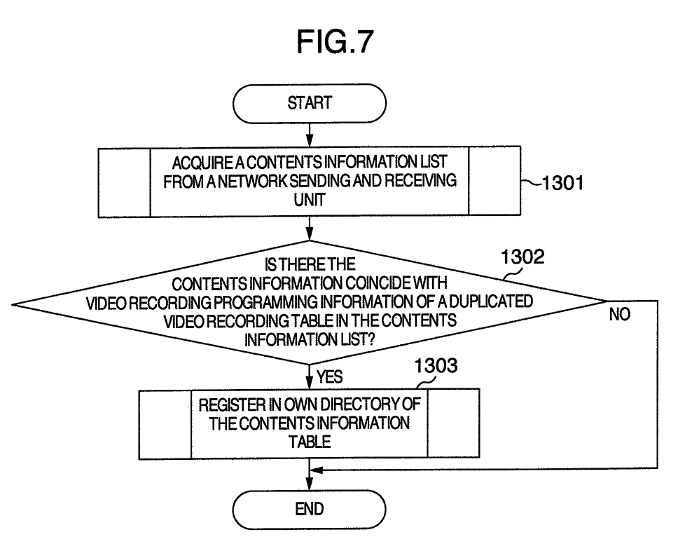

Next, explanation will be given in detail on the processing of the contents information control unit 109, with reference to FIG. 7. The contents information control unit 109 acquires the contents information list from a network sending and receiving unit (1301), and judges whether the relevant contents information list contains the contents information coincident with the video recording programming information registered in the duplicated video recording table 312 or not (1302). When coincident contents information is present, the relevant contents information is stored in own directory of the contents information table 310 (1303). When coincident contents information is not present, processing of the contents information control unit 109 is terminated.

According to the embodiment explained above, contents retrieval can be made easy, even when video recording information of the present automatic video recording apparatus is duplicated, by controlling contents information of the relevant video recording programming information executed by other video recording apparatuses, by own directory.

It should be further understood by those skilled in the art that although the foregoing description has been made on embodiments of the invention, the invention is not limited thereto and various changes and modifications may be made without departing from the spirit of the invention and the scope of the appended claims.

1. A video recording apparatus for receiving a broadcast wave and recording a broadcast program comprising:
a network sending and receiving unit for communicating with other video recording apparatuses via network;
a contents data storage unit for recording a broadcast program;
a memory unit for recording a video recording programming information table including broadcast program names, broadcast channels, recording date and time, and names of video recording apparatuses to be recorded in said contents data storage unit;
a video recording control unit for recording a broadcast program in said contents data storage unit, based on video recording programming information showing said video recording apparatus, by a video recording apparatus name of said video recording programming information table, with reference to said video recording programming information table; and
a video recording programming control unit for setting said video recording programming information table, from video recording programming information specified by a user, and video recording programming information of other video recording apparatuses acquired via said network sending and receiving unit.

2. The video recording apparatus according to claim 1, wherein
said video recording programming control unit, in the case where said video recording programming information specified by the user has not been set in said video recording programming information table, registers said video recording programming information specified by the user in said video recording programming information table, and checks video recording programming information of other video recording apparatuses acquired via said network sending and receiving unit, and said video recording programming information table, and in the case where the video recording programming information is duplicated, updates said video recording programming information table, so that said video recording programming information is recorded by other video recording apparatuses connecting to the network.

3. The video recording apparatus according to claim 1, further comprising:
a video recording information table for recording a program, where video recording programming information of said video recording apparatus is duplicated in video recording programming information of other video recording apparatuses connected to network,
wherein said video recording programming control unit, in the case where said video recording programming specified by a user has not been set in said video recording programming information table, registers said video recording programming information specified by a user in said video recording programming information table, and in the case where said video recording programming information specified by a user is already set in said video recording programming information table, registers said video recording programming information specified by a user in said duplicated video recording programming table, and in the case where said video recording programming information specified by a user is duplicated in video recording programming information of other video recording apparatuses acquired via said network sending and receiving unit, registers said video recording programming information specified by a user in said duplicated video recording table, as well as updates said video recording programming information table, so that said video recording programming information can be recorded in other video recording apparatuses connected to network.

4. The video recording apparatus according to claim 3, wherein
said video recording programming control unit checks said video recording programming information table and said duplicated video recording table, before executing programmed video recording, and transfers the video recording programming information from said duplicated video recording table to said video recording programming information table, on video recording programs not recorded in said video recording programming information table, in video recording programs of said duplicated video recording table.

5. A video recording system in which a plurality of video recording apparatuses are connected via a network, wherein
a first video recording apparatus executes acquisition request of video recording programming information to a second video recording apparatus, when video recording is programmed in the first video recording apparatus by a user;
said second video recording apparatus responds video recording programming information of said apparatus to the first video recording apparatus;
said first video recording apparatus checks video recording programming information of said apparatus, and acquired video recording programming information of said second video recording apparatus; and
as for duplicated video recording programs, a video recording programming information table of said apparatus is updated, so as to show that video recording is executed by said second video recording apparatus.
